(19) United States
(12) Patent Application Publication
(10) Pub. No.: US 2026/0324654 A1
(43) Pub. Date: Oct. 22, 2026

(54) HELICAL FOOD PROCESSING SYSTEMS

(71) Applicant: Scanico A/S, Aalborg SØ (DK)

(72) Inventors: Bent Østergaard, Gistrup (DK); Lars Kæhler, Aalborg (DK); Graeme Bunce, Goffstown, NH (US); Mark Fitzgerald, Nashua, NH (US)

(73) Assignee: Scanico A/S, Aalborg SØ (DK)

(21) Appl. No.: 19/649,393

(22) Filed: Apr. 16, 2026

Related U.S. Application Data
(60) Provisional application No. 63/790,867, filed on Apr. 18, 2025.
(60) Provisional application No. 63/897,174, filed on Oct. 10, 2025.

(51) Int. Cl. A21B 1/48; A21B 1/22; H05B 6/72; H05B 6/78

(52) U.S. Cl. CPC A21B 1/48; A21B 1/22; H05B 6/72; H05B 6/782

(57) ABSTRACT

A food processing system for processing food products includes a housing defining a processing chamber and a center cavity and a conveyor configured to convey the food products through the processing chamber along a helical path that encircles the center cavity. A first processing system is configured to direct air into the processing chamber to process the food products, and a microwave heating system is configured to generate microwave energy and direct the microwave energy into the processing chamber to process the food products. The microwave heating system includes an antenna extending into the processing chamber through which the microwave energy passes into the processing chamber.

### CROSS-REFERENCE TO RELATED APPLICATION

The present disclosure is based on and claims priority to U.S. Provisional Patent Application No. 63/790,867 filed Apr. 18, 2025, U.S. Provisional Patent Application No. 63/897,174 filed Oct. 10, 2025, and the disclosures of which are incorporated herein by reference.

### FIELD

The present disclosure relates to food processing systems, and specifically to helical food processing systems with microwave heating systems.

### BACKGROUND

The following U.S. Patent Application Publications and U.S. Patents are incorporated herein by reference in entirety.

U.S. Patent Application Publication No. 2022/0346198 discloses food processing machines for processing a food product with a microwave generating device configured to generate microwave energy. A waveguide assembly is configured to receive the microwave energy, direct the microwave energy along a waveguide axis, and subsequently direct the microwave energy to heat the food product.

U.S. Patent Application Publication No. 2024/0373883 discloses a food processing system for processing a food product that includes a module with a microwave generating device configured to generate microwave energy to process the food product, a conveyor extending through the module and configured to convey the food product through the module, and a microwave suppression system configured to prevent leakage of the microwave energy from the food processing system. The microwave suppression system includes a pin choke assembly with a plurality of pin chokes that is selectively movable relative to the conveyor to thereby vary a clearance distance between the plurality of pin chokes and the conveyor.

U.S. Pat. No. 11,291,210 discloses a spiral cooking device having a first cooking zone with air configured to move horizontally therethrough in a first direction, a second cooking zone with air configured to move horizontally therethrough in a second direction different than the first direction, and a spiral conveyor belt at least partially positioned in the first and second cooking zones and configured to transport food product thereon through the first and second cooking zones.

U.S. Pat. No. 6,604,452 discloses a food processing system that circulates a processing medium along a circulation path having first and second segments perpendicular to food product travel along a horizontal conveyor.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a food processing system for processing food products includes a housing defining a processing chamber and a center cavity and a conveyor configured to convey the food products through the processing chamber along a helical path that encircles the center cavity. A first processing system is configured to direct air into the processing chamber to process the food products, and a microwave heating system is configured to generate microwave energy and direct the microwave energy into the processing chamber to process the food products. The microwave heating system includes an antenna extending into the processing chamber through which the microwave energy passes into the processing chamber.

In certain examples, a method of processing food products includes conveying food products on a conveyor through a processing chamber of a food processing system along a helical path and heating the food products with heated air circulated through the processing chamber by a first processing system to process the food products. The method also includes applying microwave energy to the food products in the processing chamber with one or more antennas of a microwave heating system to process the food products, with the one or more antennas extending into the processing chamber.

In certain examples, a microwave antenna for a food processing system for processing food products an antenna wall that defines an internal cavity configured to receive microwave energy and a least one antenna hole in the antenna wall through which the microwave energy is emitted outwardly from the antenna wall.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIGS. 1-2 are perspective views of an example food processing system according to the present disclosure.

FIGS. 3-4 are perspective views of the example food processing system of FIGS. 1-2 with a cover and a first processing system removed.

FIG. 5 is a cross-sectional view of the example food processing system of FIGS. 1-2 along line 5-5 in FIG. 1.

FIG. 6 is a cross-sectional view of the example food processing system of FIGS. 1-2 along line 6-6 in FIG. 1.

FIGS. 7-8 are perspective views of an example antenna according to the present disclosure.

FIG. 9 is a perspective view of another example antenna according to the present disclosure.

FIG. 10 is a schematic diagram of an example control system according to the present disclosure.

FIGS. 11-12 are perspective views of another example antenna according to the present disclosure.

FIG. 13 is an end view of the antenna of FIG. 11.

FIGS. 14-15 are example methods according to the present disclosure.

### DETAILED DESCRIPTION

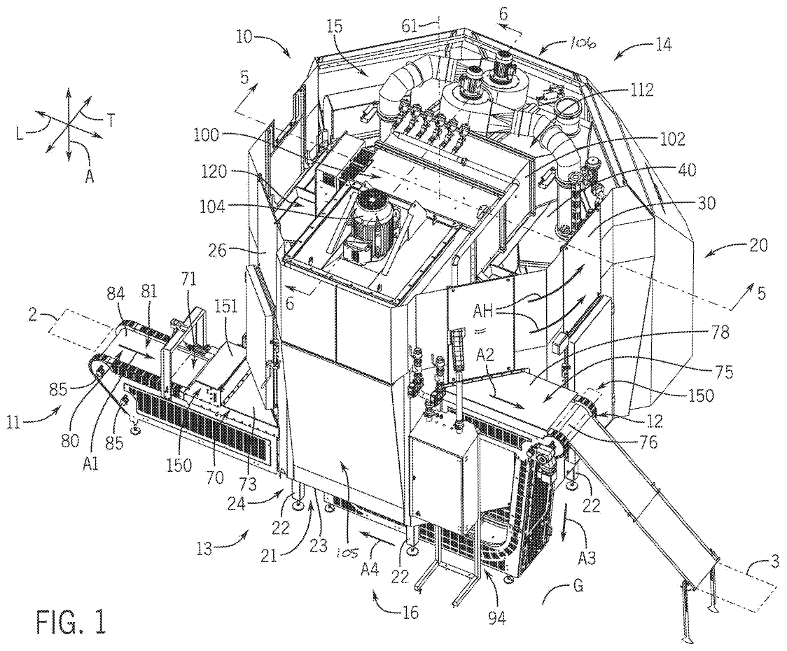

FIGS. 1-6 depicts an example food processing system 10, e.g., helical or spiral oven, according to the present disclosure. Generally, the food processing system 10 longitudinally extends between a first system end 11 and a second system end 12 (see example longitudinal axis L), laterally extends between a first system side 13 and a second system side 14, and axially between a system top 15 and a system bottom 16 (see example vertical axis A). Note that the lateral axis T and the longitudinal axis L are each also perpendicular to the example vertical axis A.

The first system end 11 is an upstream side that is configured to receive food products (e.g., chicken breasts, chicken drumsticks, nuggets, bacon, hamburgers, potato chips, snack foods), and the second system end 12 is a downstream side that is configured to dispense the cooked and/or heated food products.

The example food processing system 10 can be positioned adjacent to one or more other systems or machines. In one example, the first system end 11 is located adjacent to an upstream conveyor 2 (depicted schematically in FIG. 1) such that the first system end 11 is configured to receive the food products from the upstream conveyor 2. Similarly, the second system end 12 is located adjacent to a downstream conveyor 3 such that the processed (e.g., heated, cooked, seared, cooled, dried, browned, flavored, smoked, etc.) food products are dispensed from the second system end 12 to the downstream conveyor 3. In certain examples, an additional microwave heating system is located upstream and/or downstream from the food processing system 10. In certain examples, the food processing system 10 can be paired with another similar example food processing system such that the food products are processed by two food processing systems (e.g., the food products are first processed by one example food processing system 10 which sears the food products and a second example food processing system 10 that further heats the food products). In certain examples, a first food processing system 10 is configured to transport the food products upwardly and dispense the food products to a second food processing system 10, which can process the food products in a second cooking zone/environment (temperature, humidity, etc.) if beneficial for the cooking process.

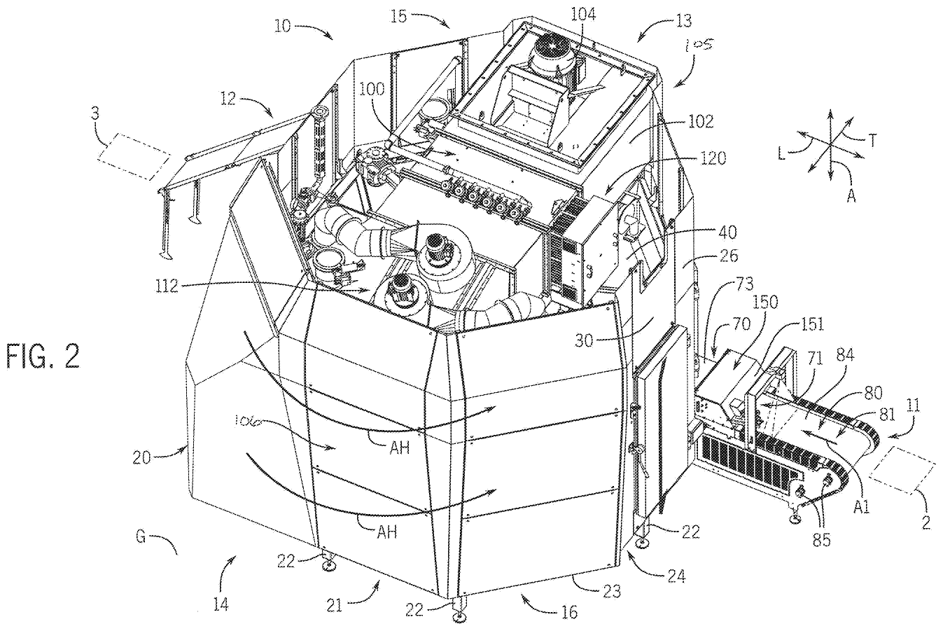

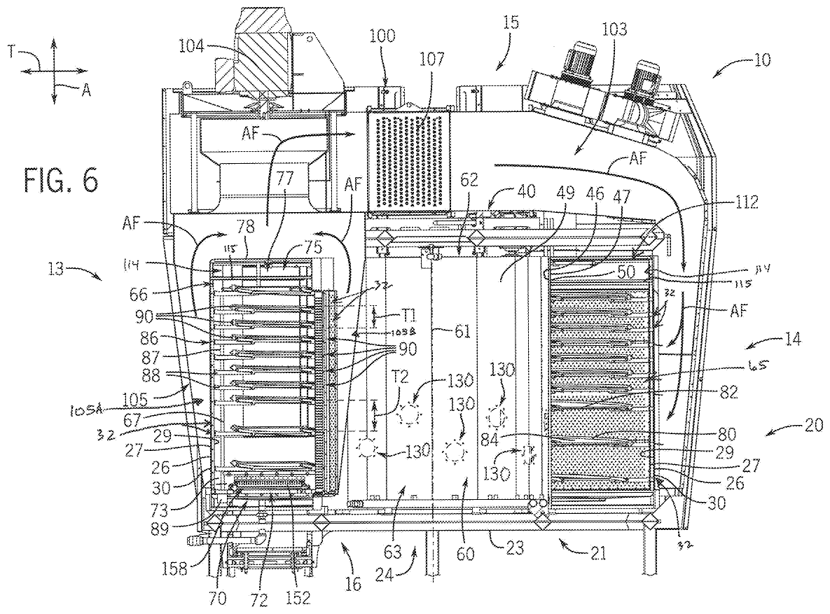

The food processing system 10 includes a housing 20 with a base 21, a pair of exterior sidewalls 26, 27, a cover 40, a pair of tunnels 70, 75, and a pair of interior sidewalls 46, 47. The base 21 is vertically supported on the ground G. The base 21 includes one or more support posts 22 (schematically depicted in FIGS. 1-2 with dashed lines) that axially extend from a base panel 23 (see also FIG. 6) and engage the ground G.

A lower cavity 24 is located between the base panel 23 and the ground G. In certain examples, the base 21 includes base panels (not depicted) that close the exterior perimeter sides of the lower cavity 24 thereby preventing inadvertent entry into the lower cavity 24. As will be described in greater detail hereinbelow, other components of the food processing system 10 are located in and/or extend through the lower cavity 24.

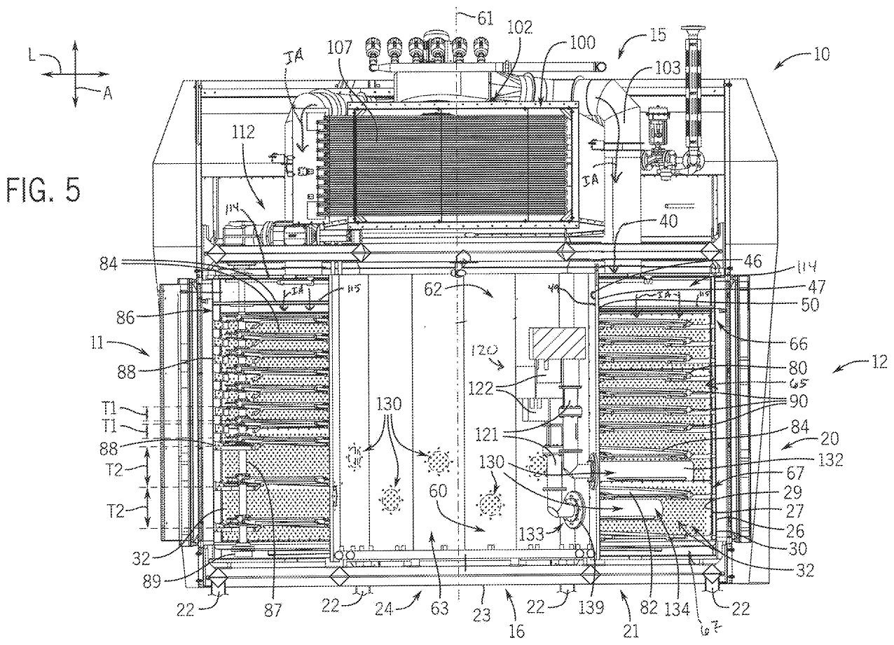

The sidewalls 26, 27, 46, 47 extend axially upwardly from the base panel 23 (see FIGS. 5-6). The interior sidewalls 46, 47, specifically the first interior sidewall 46 and the second interior sidewall 46, surround a center cavity 60 that extends axially along a center axis 61. The shape of the sidewalls 46, 47 can vary, and in certain examples, the interior sidewall 46 and/or the interior sidewall 47 can be oval, poly-edged, or circular. The first interior sidewall 46 has an interior surface 49 that faces the center cavity 60. The second interior sidewall 47 is located radially outwardly from the first interior sidewall 46, and the second interior sidewall 47 has an exterior surface 50 that faces radially outwardly toward a processing chamber 65 (described further herein).

The exterior sidewalls 26, 27, specifically the first exterior sidewall 26 and the second exterior sidewall 27, surround the center cavity 60 and a processing chamber 65 (described further herein). Specifically, the processing chamber 65 is located between the second interior sidewall 47 and the second exterior sidewall 27. The second exterior sidewall 27 has an interior surface 29 that faces the processing chamber 65. The first exterior sidewall 26 is located radially outwardly from the second exterior sidewall 27, and the first exterior sidewall 26 has an exterior surface 30 that faces radially outwardly.

The shape of the center cavity 60 can vary, such as a cylindrical shape or a corrugated or ribbed cylinder shape. The shape of the processing chamber 65 can vary, such as a generally annular shape, oval shape, or hollow cylinder shape. The center cavity 60 extends along the center axis 61 between an upper cavity end 62 and a lower cavity end 63, and the processing chamber 65 has an upper chamber end 66 and a lower chamber end 67. The base panel 23 closes the lower cavity end 63 and/or the lower chamber end 67, and the cover 40 closes the upper cavity end 62 and/or the upper chamber end 66. As such, the processing chamber 65 is generally contained within and bound by the cover 40, the base panel 23, and the second exterior sidewall 27. The processing chamber 65 can be pressurized, maintain a steady air pressure, and/or contain high velocity airflow generated by a first processing system 100 (described further herein), for further processing (e.g., finishing, browning, searing) the food products at a final process. In certain examples, the cover 40 is removable for maintenance of components in the processing chamber 65 and/or cleaning of the processing chamber 65. In certain examples, the cover 40 includes an access hatch through which an operator may access the processing chamber 65. In certain examples, the cover 40 is integrated into the ceiling of the facility in which the food processing system is located (not depicted).

The lower cavity end 63 of the center cavity 60 extends to the lower cavity 24, and accordingly, mechanical and/or electrical components (e.g., pipes, cables, wires) can be routed through the lower cavity 24 and into the center cavity 60. In other examples, the base panel 23 separates the center cavity 60 from the lower cavity 24. In these examples, mechanical and/or electrical components may or may not extend through the center panel between the lower cavity 24 and the center cavity 60.

The housing 20 includes an inlet tunnel 70 that defines an inlet 71 and an inlet passageway 72 (see FIG. 6). The inlet tunnel 70 has tunnel walls 73 that cover the inlet passageway 72. The tunnel walls 73 extend from the first exterior sidewall 26 and/or into the processing chamber 65 from the second exterior sidewall 27. Note that in other examples, the inlet tunnel 70 is excluded and the exterior sidewalls 26, 27 define the inlet 71 through the exterior sidewalls 26, 27 and into the processing chamber 65.

The housing 20 includes an outlet tunnel 75 that defines an outlet 76 and an outlet passageway 77 (see FIG. 6). The outlet tunnel 75 has tunnel walls 78 that surround the outlet passageway 77. The tunnel walls 78 extend from the first exterior sidewall 26 and into the processing chamber 65 from the second exterior sidewall 27. Note that in other examples, the outlet tunnel 75 is excluded and the exterior sidewalls 26, 27 define the outlet 76 through the exterior sidewalls 26, 27 and into the processing chamber 65.

Note that the components of the housing 20 (e.g., the base 21, the sidewalls 26, 27, 46, 47, the cover 40) provide structural support and rigidity for the food processing system 10 including the components described below. In other examples, the food processing system 10 has a support structure (not depicted) that supports the housing 20 and other components of the food processing system 10.

The food processing system 10 includes a conveyor 80 configured to convey the food products through the processing chamber 65. The conveyor 80 can be any suitable device, and in the example depicted in FIGS. 1-6, the conveyor 80 is an endless belt conveyor with a belt 84 on which the food products are placed. The belt 84 can be formed with any suitable material such as rubber, plastic, metallic materials, panels, and/or the like. The conveyor 80 can include other components such as chains, motors, rollers, plates, hooks, troughs, non-metallic belts, and/or the like.

The belt 84 includes an inlet first belt section 81, a helical or spiral second belt section 82, and an outlet third belt section 83. The first belt section 81 extends in a first direction (arrow A1) through the inlet 71 and the inlet tunnel 70. The second belt section 82 extends through the processing chamber 65 and encircles the center cavity 60. The second belt section 82 is configured to transport the food products along a helical path (see arrows AH) through the processing chamber 65. The second belt section 82 conveys the food products in an axially upward direction along a plurality of belt tiers 90 of the second belt section 82 that are ‘stacked’ relative to each other within the processing chamber 65. The number of belt tiers 90 can vary and can be based on the height of the processing chamber 65. In one example, the second belt section 82 has eight belt tiers 90 that are stacked in the processing chamber 65.

One or more of the belt sections 81-83 are supported by a plurality of conveyor support members (not depicted; e.g., rods, beams, plates) that support the belt sections 81-83. For example, the support members support the second belt section in the processing chamber 65 and the support members extend under the width of the belt 84. The ends of the support members may be interconnected by a plurality of links (not depicted). In one example, the support members and the links form a track that guides the belt 84 in the helical path (arrows AH) through the processing chamber 65 and supports the belt tiers 90. One or more belt sections 81-83 can also or alternatively be supported by a plurality of rollers 85 (e.g., idle rollers, drive rollers) examples of which are depicted in FIGS. 1-2. Reference is made to above-incorporated U.S. Pat. No. 11,291,210 for conventional conveyor components and features that can be utilized with the example systems of the present disclosure for supporting the belt.

The belt 84 can be driven by pulleys, sprockets, or rollers 85 that are rotated by a motor. The belt 84 can also be driven by one or more conveyor drive members 86 (see FIG. 6) that engage the second belt section 82 at each belt tier 90. The number of belt tiers 90 (e.g., four belt tiers, nine belt tiers, twenty belt tiers) and the tier spacing T1, T2 (see FIG. 5) (e.g., 30.0 millimeters, 120.00 millimeters) between the belt tiers 90 can vary. In other examples, the tier spacing T1, T2 can be a value in or at the ends of the range of 10.0-900.0 millimeters. In the example depicted in FIG. 6, the second belt section 82 includes eleven belt tiers 90 in a stacked configuration and certain belt tiers 90 have a first tier spacing T1 of 120.0 millimeters (mm) or a second tier spacing T2 of 300.0 mm, making room for a microwave antenna 130 (described further herein). Note that the tier spacing can be customized to correspond to or accommodate the heights or thicknesses of the food products. Note that the conveyor support members are excluded from FIGS. 5-6 for clarity. Note that the tier spacing T1, T2 and position of the belt tiers 90 in different spacings/heights in the helical spiral can vary for various reasons such as accommodating food products with different and/or increasing or decreasing the number of belt tiers 90 of the second belt section 92. In certain examples, if a certain product process requires microwave heating in the middle of the process, the tier spacing T2 can be designed in the middle of the processing chamber 65 to make space for components of the microwave heating system 120 (described further herein).

One or more conveyor drive members 86 (see FIGS. 5-6) are located adjacent to the radially outward edge of the belt 84 and configured to engage the belt 84 to drive the belt 84 along the second belt section 82. The conveyor drive member 86 includes an axially extending shaft 87, a plurality of sprockets 88 spaced apart along the shaft 87, and a motor 89 that drives/rotates the shaft 87 to thereby rotate the sprockets 88. The rotating sprockets 88 drive the belt 84 at each belt tier 90. Note that although two conveyor drive members 86 are depicted in FIGS. 5-6, the food processing system 10 can include any number of conveyor drive members 86 or other devices for conveying the belt 84. Reference is made to above-incorporated U.S. Pat. No. 11,291,210 for conventional conveyor components and features that can be utilized with the example systems of the present disclosure for driving the belt.

During operation of the conveyor 80, the belt 84 is circulated through the food processing system 10 in the first direction (arrow A1) from the first system end 11 through the inlet 71 and/or a portion of the inlet tunnel 70. The belt 84 is further conveyed in the helical direction (arrows AH) and an upward direction through a portion of the inlet tunnel 70 and/or the processing chamber 65. The belt 84 is further conveyed in a second direction (arrow A2) through the outlet 76 and/or a portion of the outlet tunnel 75. After the food products are dispensed from the belt 84 at the second system end 12, the belt 84 is routed in a third direction (arrow A3) axially downwardly and/or upwardly and a fourth direction (arrow A4) back to the first system end 11.

In certain examples, the food processing system 10 includes a belt tensioning device (not depicted) for tensioning the belt 84. In certain examples, the food processing system 10 includes a belt wash system 94 for washing the belt 84 of debris and/or residual portions of the food product before the belt 84 is recirculated through the processing chamber 65.

The food processing system 10 includes a first processing system 100, which in certain examples is a forced-air convection heating system to heat up circulating airflow, that is configured to process the food products while the food products are conveyed by the conveyor 80 through the processing chamber 65. The power/heating source of heating in the first processing system 100 can vary such as electrical heating, hot oil, gas heating, and/or the like. The first processing system 100 includes a duct enclosure 102 that is coupled to the housing 20. The duct enclosure 102 defines a pathway 103 along which heated air is at least partially conveyed by a fan 104. The duct enclosure 102 has a first duct end 105 that is coupled to the first system side 13 and a second duct end 106 that is coupled to the second system side 14. This first processing system 100 can be or include other types of processing systems, such as systems that circulate unheated or cooled air and/or include components such as infrared heating devices, resistive heating elements, hot oil heating elements, and the like.

The fan 104 is optionally located in the pathway 103 and is configured to convey air through the pathway 103 and the processing chamber 65 (described further herein). One or more heating elements 107 are also located in the pathway 103, and the heating elements 107 are configured to heat the air that is conveyed by the fan 104 from the first duct end 105 to the second duct end 106 along an airflow path (see arrow AF). The heating elements 107 can be any suitable heating element such as burners, radiant electric coils, thermal oil coils, and/or the like. In certain examples, the first processing system 100 can include humidifiers (for increasing the humidity of the air), dehumidifiers (for decreasing the humidity of the air), and/or heat exchangers (for cooling or heating the air).

In one example operation, the fan 104 draws air from a first duct portion 105A of the first duct end 105 at the outer radius of the belt 84 and a second duct portion 105B of the first duct end 105 at the inner radius of the belt 84 (see FIG. 6). The air is drawn into the first duct end 105 from the processing chamber 65 via holes 32 in the sidewalls 26, 27, 46, 47. Note that the duct portions 105, 105B cover the holes 32 in the sidewalls 26, 27, 46, 47. The fan 104 conveys the air from the first duct end 105 through the heating elements 107 that heat the air to a predetermined temperature. The heated air is further conveyed through the pathway 103 to the second duct end 106 where the heated air is directed through the holes 32 in the exterior sidewalls 26, 27 at the second system side 14 and into the processing chamber 65. The heated air thereby processes (e.g., cooks, sears) the food products on the belt 84 in the processing chamber 65. The air is conveyed (e.g., by air pressure) throughout the processing chamber 65 and further exits the processing chamber 65 through the exterior sidewalls 26, 27 and/or the interior sidewalls 46, 47 at the first system side 13. The first duct end 105 collects the air passing through the sidewalls 26, 27 and/or the sidewall 46, 47 and directs the air back to the fan 104 such that the air can be recirculated in a similar manner as is described above. Note that in other examples, the pair of sidewalls 26, 27 may be replaced with a single sidewall with the holes 32 therein. Note that in other examples, the pair of sidewalls 46, 47 may be replaced with a single sidewall with the holes 32 therein.

In certain examples, the first processing system can include an air exhaust system (not depicted) for exhausting air from the food processing system 10 and/or maintaining optimum temperature (wet bulb temperature and dry bulb temperature) and/or humidity for the food products being conveyed through the processing chamber 65. In certain examples, the first processing system can include steam, flavoring, and/or smoke injection systems (not depicted) that are configured to inject steam, flavoring, or smoke into the processing chamber 65.

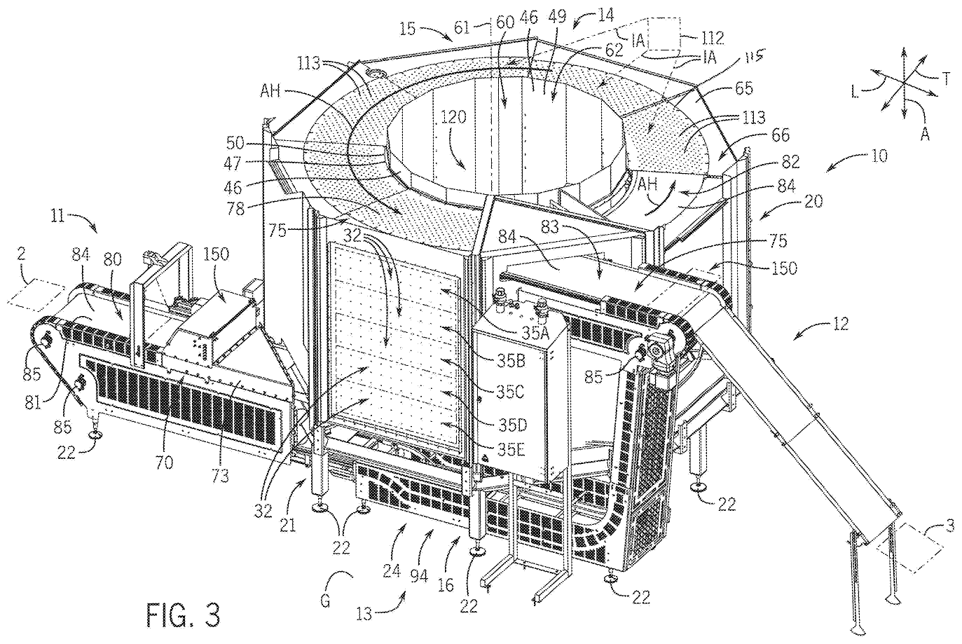

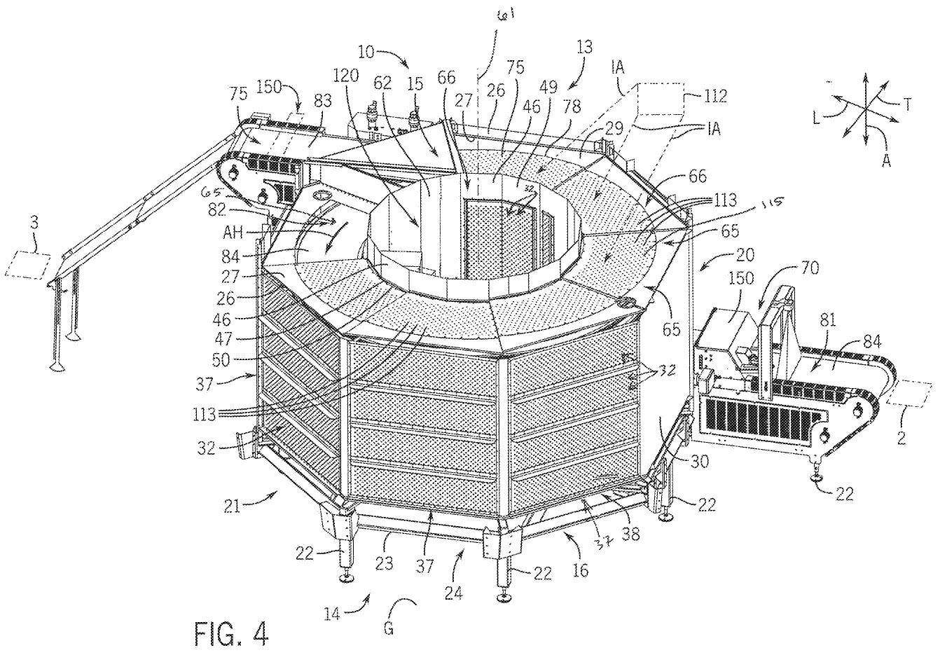

As noted above, the air is conveyed through the exterior sidewalls 26, 27 sidewalls into the processing chamber 65, and specifically, the air is conveyed through a plurality of holes 32 in the sidewalls 26-27. FIGS. 3-4 depict the components of the first processing system 100, such as the duct enclosure 102, the fan 104, and the heating elements 107, removed to thereby depict the holes 32 in greater detail. FIG. 3 depicts the holes 32 in the exterior sidewalls 26, 27 at the first system side 13. The sections of the first exterior sidewalls 26 with the holes 32 therein are covered by the first duct end 105 and to prevent the air from escaping the food processing system 10. Similarly, FIG. 4 depicts the holes 32 in the exterior sidewalls 26, 27 at the second system side 14. The sections of the first exterior sidewalls 26 with the holes 32 therein are covered by the second duct end 106 to prevent the air from escaping the food processing system 10.

The holes 32 are arranged at the first system side 13 and/or the second system side 14 are arranged in a predetermined pattern to thereby facilitate and optimize airflow through the processing chamber 65 and advantageously promote consistent and/or even cooking of the food products on the belt 84 in the processing chamber 65. The size of the holes 32 can also vary, and in one example, the holes 32 have a diameter of 30.0 mm or less. In other examples, the diameter of the holes 32 have a diameter or width in the range of 2.0-150.0 mm and may be a diameter or width at the ends of the noted range. In certain examples, the hole 32 has a major size/length/diameter that is less than the wavelength of the microwave energy (e.g., the wavelength of microwave at 2450.0 MHz is approximately 122 millimeters, the wavelength of microwave at 915 MHz is approximately 328 millimeters). The holes 32 can be circular, oval, or other suitable shapes. The spacing between the holes 32 can vary (e.g., spacing between the holes 32 is a center distance 2.5 multiplied by the diameter of the hole 32 or 3.0 multiplied by the diameter of the hole 32). The spacing and/or diameter of the holes 32 optimizes the pressure loss and air speed of the air circulating through the processing chamber 65. For example, the holes 32 are arranged such at pressure loss across the sidewall 26 is varied along the axial height of the processing chamber 65 The holes 32 including certain characteristics of the holes 32 (such as size and spacing pattern) can be configured to (a) to choke (keep in) the microwaves in the processing chamber 65 thereby preventing microwaves from leaking from the food processing system 10 and/or (b) control the desired airflow over the food products in the processing chamber 65. Furthermore, the holes 32 prevent the microwaves from emitting into the duct enclosure 102 and thereby prevent microwaves from influencing sensors and/or other electrical components. In certain examples, the major size/length/diameter of the holes 32 is smaller than ¼ of a wavelength to reduce the leakage from the processing chamber 65 due to the nature and physics of waves and/or for efficient microwave dampening.

In one example, the holes 32 located at the first system side 13 have the same diameter (e.g., 30.0 mm), however, the holes 32 are arranged into five axially spaced zones 35A-E with each zone having a different spacing between the holes 32 in each zone (see FIG. 3). For instance, the zone 35A located near the system top 15 has a spacing of 85.0 mm between the holes 32 in that zone 35A and the zone 35E located near the system bottom 16 has a spacing of 60.0 mm between the holes 32 in that zone 35E. The spacing of the holes 32 in the zones 35B-E gradually decreases in a downward axial direction from the spacing of the holes 32 in the zone 35A. Note the spacing between the holes 32 can vary between the zones, and in certain examples, the spacing in each of the zones could a value in the range of 5.0-150.0 mm. Reducing the spacing between the holes 32 in an axially downward direction advantageously optimizes air flow through the processing chamber 65. As such, the velocity of the air passing through the holes 32 in zone 35A is less than the velocity of the air passing through the holes 32 in zone 35E thereby promoting even cooking of the food product at all belt tiers 90. In certain examples, the spacing between adjacent holes 32 decreases in a downward axial direction to allow for increased airflow velocity at lower portions of the processing chamber 65. In certain examples, the food products being conveyed through the food processing system 10 may require a larger amount of air flow to process the food products thereby the number and/or size of the holes 32 increases to facilitate additional air flow. In certain examples, the holes 32 can be arranged in any number of zones 35 (e.g., one zone, two zones, nine zones, fifteen zones)

In another example, the holes 32 located at the second system side 14 have the same diameter and are arranged in parallel lines along three sections 37 of the exterior sidewalls 26, 27. In some examples, at least one of the sections 37 (see reference number 38) of the exterior sidewalls 26, 27 includes a greater number of holes 32 with a smaller diameter relative to the number and size of the holes included with one of the other sections 37 (note that FIG. 4 depicts the section 38 with the same number and spacing of holes).

The food processing system 10 includes a second processing system, which in this example is a microwave heating system 120, that is configured to process (e.g., sear, cook, heat, brown) the food products while the food products are conveyed by the conveyor 80 through the processing chamber 65. Specifically, the microwave heating system 120 is configured to generate microwave energy (also referred to herein as microwaves) and apply the microwaves to the food products as the food products are conveyed through the processing chamber 65 by the belt 84 to thereby further process (e.g., heat, cook, sear) the food products.

Referring to FIGS. 5-6, the microwave heating system 120 includes a waveguide assembly 121 for directing microwaves from a microwave generating device 122, such as a magnetron, configured to generate microwaves to one or more microwave antennas 130. Note that the microwave heating system 120 can include any number of waveguide assemblies 121, microwave generating device 122, and microwave antennas 130, and FIG. 5 depicts numerous antennas 130 and two waveguide assemblies 121 and microwave generating devices 122 for clarity. In certain examples, each antenna 130 is coupled to a separate waveguide assembly 121 and microwave generating device 122. The magnetrons are configured to emit microwave energy at 2450.0 MHz (or another frequency, such as 915.0 MHz.). Note that the microwave heating system 120 can include other components such as a polarizer, transformer, capacitor, or cooling fan/blower. An example of a commercially available assembly containing a magnetron and related components is available from MKS Instruments (part numbers TXO and TXA). One or more power supply units (e.g., battery, cord to facility electrical system) supply electrical power to the magnetron 122. Note that while FIG. 5-6 depicts the microwave heating system 120 one magnetron 122 and a waveguide assembly 121 for distributing the multiple microwave antennas 130, the microwave heating system 120 can include any number of magnetrons, waveguides, and antennas (e.g., one waveguide connected to one magnetron and one antenna). Reference is made to above-incorporated U.S. Patent Application Publication No. 2022/0346198 for components and features of conventional microwave processing systems that can be utilized with the example systems of the present disclosure to utilize microwave energy to process food products.

One or more components of the microwave heating system 120 are located in the center cavity 60. In the example depicted in FIG. 5-6, the magnetron 122 and the waveguide assembly 121 are in the center cavity 60. A plurality of microwave antennas 130 (described further herein) are coupled to the interior sidewalls 46, 47 and extend outwardly into the processing chamber 65. In certain examples, the antennas 130 extend radially into the processing chamber 65 relative to the center axis 61. Microwaves generated by the magnetron 122 propagate through the waveguide assembly 121 and into the microwave antennas 130. The microwave antennas 130 distribute the microwaves into the processing chamber 65. The microwave antennas 130 extend between adjacent belt tiers 90 and are configured to distribute the microwaves generally downwardly onto the food products being conveyed on the belt 84 below the microwave antennas 130. The microwave antennas 130 are depicted between two belt tiers 90, and in other examples, the microwave antennas 130 can be located between more than two belt tiers 90. For example, a first set of microwave antennas 130 are located between two belt tiers 90 near the base panel 23 and a second set of microwave antennas 130 are located between two belt tiers 90 toward the upper chamber end 66. In another example, the microwave antennas 130 are located near the upper chamber 66 or the lower chamber end 67.

Note that the sidewalls 26, 27, 46, 47, the cover 40, and the base panel 23 are configured to contain the microwave energy in the processing chamber 65 thereby preventing or choking the microwaves from leaking from the food processing system 10. The holes 32 in the sidewalls 26, 27, 46, 47 act as microwave chokes that prevent microwaves from passing out into the duct enclosure 102 while still permitting heating air from the first processing system 100 to enter and circulate through the processing chamber 65 (as described above). In certain examples, the plurality of holes 32 collectively act as a microwave choke structure.

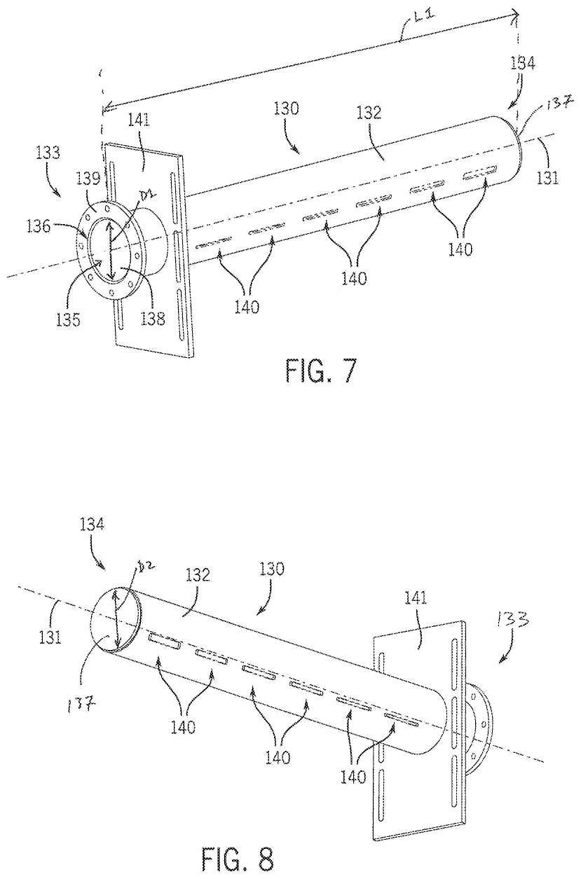

Referring now to FIGS. 7-8 depict an example antenna 130 according to the present disclosure. The antenna 130 extends along an antenna axis 131 between a first antenna end 133 and an opposite second antenna end 134. The first antenna end 133 is open and has an opening 136. The second antenna end 134 is closed and has a cap 137. The antenna 130 includes an antenna wall 132 that extends between the antenna ends 133, 134, and an interior space 135 is defined in the antenna 130. In certain examples, the antenna 130 has a first diameter D1 in the interior space 135 between the inner surface 138 of the antenna wall 132 at the first antenna end 133 and a second diameter D2 in the interior space 135 between the inner surface 138 at the second antenna end 134. In certain examples, the first diameter D1 is greater than the second diameter D2, and the antenna 130 is tapered in a direction from the first antenna end 133 to the second antenna end 134. In certain examples, the diameter of the antenna 130 varies along the length L1 of the antenna 130 between the antenna ends 133, 134. The shape of the antenna 130 can vary, and in other examples, the antenna 130 has the same diameter or width from the first antenna end 133 to the second antenna end 134 (e.g., cylindrical), can be conical, and/or divided into two sections, depending on the desired microwave emission pattern.

The first antenna end 133 can include a flange 139 for coupling to the waveguide assembly 121 (see FIGS. 5-6) with any suitable fasteners such as bolts and/or screws. A bracket 141 can be coupled to the antenna 130 between the antenna ends 133, 134, and the bracket 141 is in that case for coupling to the first interior sidewall 46 (see FIGS. 5-6) with any suitable fasteners such as bolts and/or screws.

The antenna 130 includes a plurality of antenna holes 140 (depicted in dashed lines), the shape of which can vary, in the antenna wall 132 through which the microwaves pass. The number, shape, size, orientation, and/or arrangement of the antenna holes 140 can vary and are designed to permit propagation and/or distribution of the microwaves from the antenna 130 in accordance with microwave physical behavior and theory.

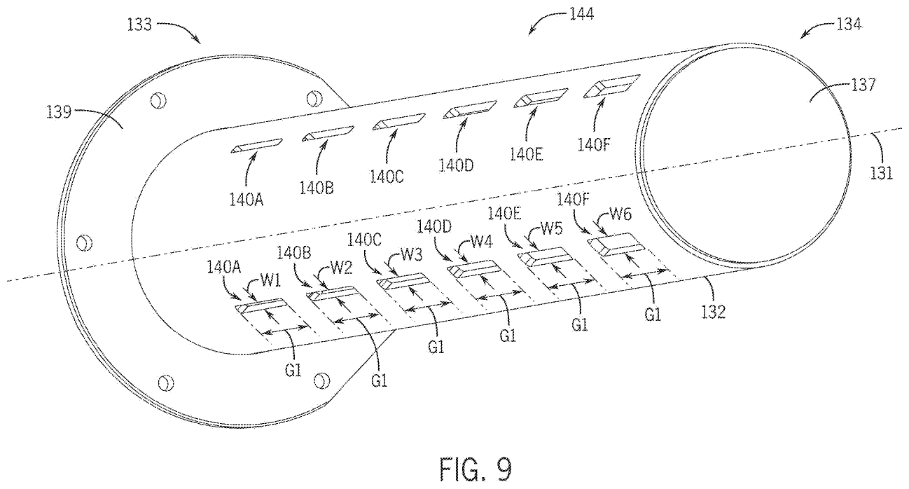

FIG. 9 is another example antenna 144 according to the present disclosure. The example antenna depicted in FIG. 9 can include one or more features and/or components (e.g., the flange 139, arrangement of the antenna holes 140) described with reference to the other example antenna 130 described above with respect to FIGS. 7-8. Similarly, the antenna 130 described with reference to FIGS. 7-8 can include any features and/or components described herein below with reference to the antenna 144. Note that some features and/or components of the antenna 144 described with reference to FIG. 9 that are similar to the features and/or components of the antenna 130 described with reference to FIGS. 7-8 are denoted with the same part numbers, however, it should be understood that the use of the same part numbers for features and/or components of the present disclosure should not be construed to indicate that the similarly marked features and/or components are necessarily identical. Instead, the similarly marked features and/or components may have varying features or characteristics. For instance, each antenna hole 140 depicted in FIG. 7-8 has the same width while the antenna holes 140 depicted in FIG. 9 have different widths.

The example antenna 144 depicted in FIG. 9 includes a flange 139 that is configured to be coupled to the first interior sidewall 46 and the waveguide assembly 121 (see FIGS. 5-6). A gasket (not depicted) is located between the flange 139 and the first interior sidewall 46. The antenna 144 includes two sets of antenna holes 140A-F that are arranged in two rows that extend between the antenna ends 133, 134. Each set of antenna holes 140A-F is configured to permit passage of the microwaves therethrough from the interior space. Each antenna hole 140A-F has a length G1 (e.g., 60.0 mm), and the width W1-6 of the antenna holes 140A-F increases in a direction from the first antenna end 133 to the second antenna end 134. For example, the first antenna hole 140A has a first width W1, the second antenna hole 140B has a second width W2 that is greater than the first antenna hole 140A, the third antenna hole 140C has a third width W3 that is greater than the second antenna hole 140B, the fourth antenna hole 140D has a fourth width W4 that is greater than the third antenna hole 140C, the fifth antenna hole 140E has a fifth width W5 that is greater than the fourth antenna hole 140D, and the sixth antenna hole 140F has a sixth width W6 that is greater than the fifth antenna hole 140E. The width of the antenna holes 140A-F advantageously increases from the first antenna end 133 to the second antenna end 134 to optimize this specific case of power distribution. In certain examples, the widths and lengths of the antenna holes 140A-F can be a value in or at the ends of the range of 5.0-120.0 millimeters.

Referring back to FIGS. 3-6, in certain examples, the food processing system 10 includes an impingement system 112 that is configured to apply air, for example high-velocity air, which may be at any suitable temperature (e.g., cold air, hot air, room-temperature air), to the food products to further process (e.g., brown, cool) the food products on the belt 84. The impingement system 112 may receive air from the first processing system via a damper 118 (see FIG. 5; note at arrow IA depicting the airflow through the impingement system 112). In other examples, the impingement system 112 has separate processing systems (e.g., a processing system to the first processing system described herein) and/or components (e.g., fans, heating elements) for receiving air flow from and/or increasing flow and temperature of the air.

The impingement system 112 is schematically depicted in FIGS. 3-6, and the impingement system 112 is configured to direct air flow (see arrows IA) onto the food products being conveyed by the conveyor 80 along the helical path (arrows AH). The air flow (see arrow IA) is received into an impingement chamber 114 located in the processing chamber 65 the upper chamber end 66. Note that in other examples, the impingement chamber 114 is above the processing chamber 65. The impingement chamber 114 is between the second interior sidewall 47 and the second exterior sidewall 27 and the cover 40 and an impingement panel 115 in which a plurality of holes 113 are defined. The air flow (arrows IA) passes through the holes 113 to thereby process the food products on the belt 84. Note that the impingement chamber 114 may be pressurized and/or the air within the impingement chamber 114 has a higher air pressure and/or velocity than the other sections of the processing chamber 65 (such as the section of the processing chamber 65 through which the belt 84 extends). In certain examples, the holes 113 have a diameter or width of 2.0-60.0 millimeters and may be a diameter or width at the ends of the noted range. In certain examples, the holes 113 have a diameter or width of 5.0-7.0 millimeters and may be a diameter or width at the ends of the noted range. The shape of the holes 113 can vary (e.g., circular, oval), and note that the layout can vary based on differences in product travel speed between the inner radius and the outer radius of the conveyor 80.

The length of the impingement chamber 114 and/or the impingement panel 115 can vary. For instance, the impingement chamber 114 and/or the impingement panel 115 could extend along more than half the uppermost belt tier 90 of the food processing system 10. In other examples, the length of the impingement chamber 114 and/or the impingement panel 115 extends along half the uppermost belt tier 90. In other examples, the length of the impingement chamber 114 and/or the impingement panel 115 extends along less than half of the uppermost belt tier 90. Note that in certain examples, the length of the impingement chamber 114 and/or the impingement panel 115 corresponds to or follows at least a portion of the helical path AH.

In other examples, the impingement system 112 directs the air (see arrows IA) through holes 113 in the tunnel walls 73 of the outlet tunnel 75 such that the air processes the food products being conveyed by the conveyor 80 along the helical path (see arrows AH). The length of the outlet tunnel 75 can vary. For instance, the outlet tunnel 75 could extend along more than half the uppermost belt tier 90 of the food processing system 10. In other examples, the length of the outlet tunnel 75 extends along half the uppermost belt tier 90. In other examples, the length of the outlet tunnel 75 extends along less than half of the uppermost belt tier 90. Note that in certain examples, the length of the outlet tunnel 75 corresponds to or follows at least a portion of the helical path AH. In certain examples, the impingement system 112 processes the food product as the food products are conveyed through the outlet tunnel 75 near the outlet 76. In certain examples, the impingement system 112 processes the food products after the processing of the food product by the first processing system 100 and/or the microwave heating system 120 near the end of the outlet 76.

Referring back to FIGS. 1-2, in certain examples, the food processing system 10 includes a microwave suppression device 150 at the inlet tunnel 70 and/or the outlet tunnel 75. The microwave suppression devices 150 are for preventing microwaves from leaking from the food processing system 10 from the inlet 71 or the outlet 76. The microwave suppression device 150 can be any suitable device for preventing microwaves from leaking from the food processing system 10 such as a water jacket and/or pin chokes or curtain chokes. In the example depicted in FIG. 1-2, the microwave suppression device 150 includes a cover 151, a frame (not depicted) with a plurality of pin chokes (reference number 152 see FIG. 6) coupled thereto. The frame is L-shaped, and the pin chokes 152 are on both legs of the frame and the pin chokes 152 on one of the legs extend perpendicular to the pin chokes 152 on the other leg. Reference is made to above-incorporated U.S. Patent Application Publication No. 2024/0373883 for components and features of conventional microwave suppression systems that can be utilized with the example systems of the present disclosure to prevent microwaves from leaking from the system.

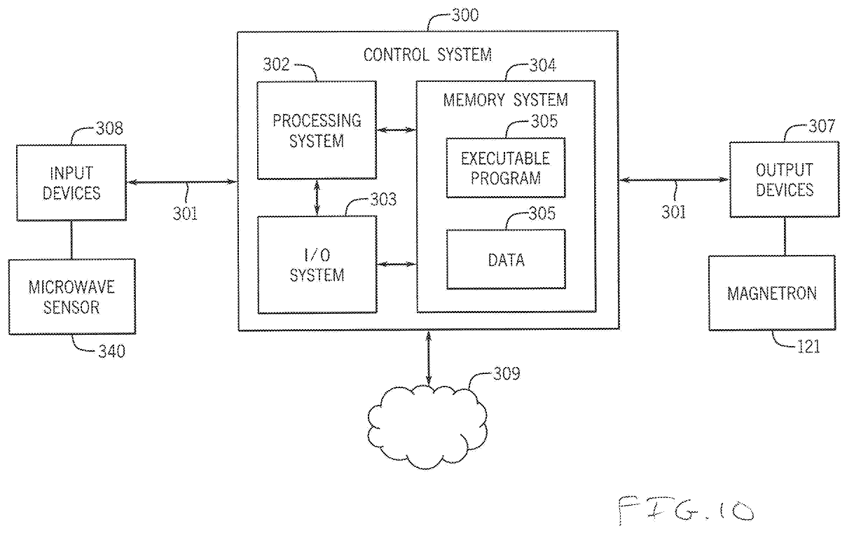

Referring now to FIG. 10, an example control system 300 of the food processing system 10 (FIG. 1) is depicted. The control system 300 is for controlling the operation of the food processing system 10 and the various components, systems, and features noted above. The control system 300 can include various components, modules, and/or subsystems, some of which are described herein below.

Certain aspects of the present disclosure are described or depicted as functional and/or logical block components or processing steps, which may be performed by any number of hardware, software, and/or firmware components configured to perform the specified functions. For example, certain embodiments employ integrated circuit components, such as memory elements, digital signal processing elements, logic elements, look-up tables, or the like, configured to carry out a variety of functions under the control of one or more processors or other control devices. The connections between functional and logical block components are merely exemplary, which may be direct or indirect, and may follow alternate pathways.

In certain examples, the control system 300 communicates with each of the one or more components of the food processing system 10 via a communication link 301, which can be any wired or wireless link. The control system 300 is capable of receiving information and/or controlling one or more operational characteristics of the food processing system 10 and its various sub-systems by sending and receiving control signals via the communication links 301. In one example, the communication link 301 is a controller area network (CAN) bus; however, other types of links could be used. It will be recognized that the extent of connections and the communication links 301 may in fact be one or more shared connections, or links, among some or all of the components in the food processing system 10. Moreover, the communication link 301 lines are meant only to demonstrate that the various control elements are capable of communicating with one another, and do not represent actual wiring connections between the various elements, nor do they represent the only paths of communication between the elements. Additionally, the food processing system 10 may incorporate various types of communication devices and systems, and thus the illustrated communication links 301 may in fact represent various different types of wireless and/or wired data communication systems.

The control system 300 may be a computing system that includes a processing system 302, memory system 304, and input/output (I/O) system 303 for communicating with other devices, such as input devices 308 (e.g., touchscreen display panel, microwave sensor 340) and output devices 307 (e.g., audio alarm, steam jet, magnetron 122), either of which may also or alternatively be stored in a cloud 309. The processing system 302 loads and executes an executable program 305 from the memory system 304, accesses data 306 stored within the memory system 304, and directs the food processing system 10 to operate as described in further detail below.

The processing system 302 may be implemented as a single microprocessor or other circuitry, or be distributed across multiple processing devices or sub-systems that cooperate to execute the executable program 305 from the memory system 304. Non-limiting examples of the processing system include general purpose central processing units, application specific processors, and logic devices.

The memory system 304 may comprise any storage media readable by the processing system 302 and capable of storing the executable program 305 and/or data 306. The memory system 304 may be implemented as a single storage device, or be distributed across multiple storage devices or sub-systems that cooperate to store computer readable instructions, data structures, program modules, or other data. The memory system 304 may include volatile and/or non-volatile systems, and may include removable and/or non-removable media implemented in any method or technology for storage of information. The storage media may include non-transitory and/or transitory storage media, including random access memory, read only memory, magnetic discs, optical discs, flash memory, virtual memory, and non-virtual memory, magnetic storage devices, or any other medium which can be used to store information and be accessed by an instruction execution system, for example.

In certain examples, the magnetron 122 is in communication with the control system 300 such that operation of the magnetron 122 and thereby the microwave energy generated can be controlled (described further herein). One or more microwave sensors 340 are configured to sense microwave energy propagating through the waveguide assemblies. The microwave sensors 340 provide microwave data to the control system 300 that corresponds to the amount of microwave energy within the processing chamber 65. The control system 300 can process the microwave data and/or provide control signals to the magnetron 122 to thereby adjust the microwaves emitted into the processing chamber 65 (FIG. 3) via the waveguide assembly 121 and the antennas 130. In certain examples, the microwave sensor(s) 340 can be configured to sense microwaves outside of the microwave suppression devices 150 and communicate signals to the control system 300 which may take action (e.g., the control system 300 may alert the operator that microwaves are leaking for the food processing system 10 or turn off the microwave generating devices).

In certain examples, the control system 300 functions complementarily with the microwave suppression devices 150 and/or communicates with workload measurement systems (that may include various sensors) to prevent microwave leakage from the food processing system 10 by monitoring the amount of food products being processed by the food processing system 10. In certain examples, a 3D camera or volume scanner (e.g., camera, laser curtain) scans the ingoing amount of food products (e.g., volume of the food product) into the food processing system 10 and is used to turn up and down for the microwave power for each antenna 130, as the food products reach the specific antennas 130 or areas around the antennas at the food products are conveyed through the processing chamber 65. In certain examples, a 3D camera or volume scanner scans the ingoing amount of food products into the food processing system 10 and the control system uses the data from the scanner to determine the amount of microwaves that should be directed into the processing chamber 65 so that the food products absorb the microwaves in the processing chamber. If the food products do not absorb the microwaves (e.g. due to the less food products in the processing chamber and amount of microwaves used begin for more food products than what is actually being conveyed through the processing chamber), the excess microwaves could leak from the food processing system 10 and/or present a danger to the food processing system 10 and/or workers.

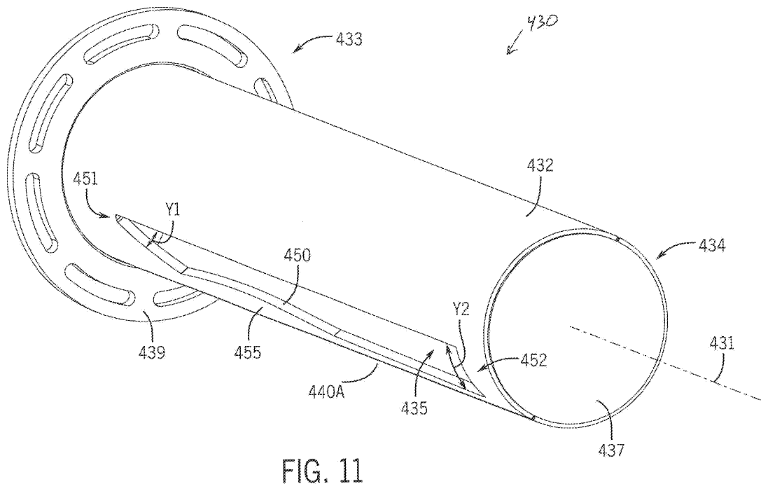

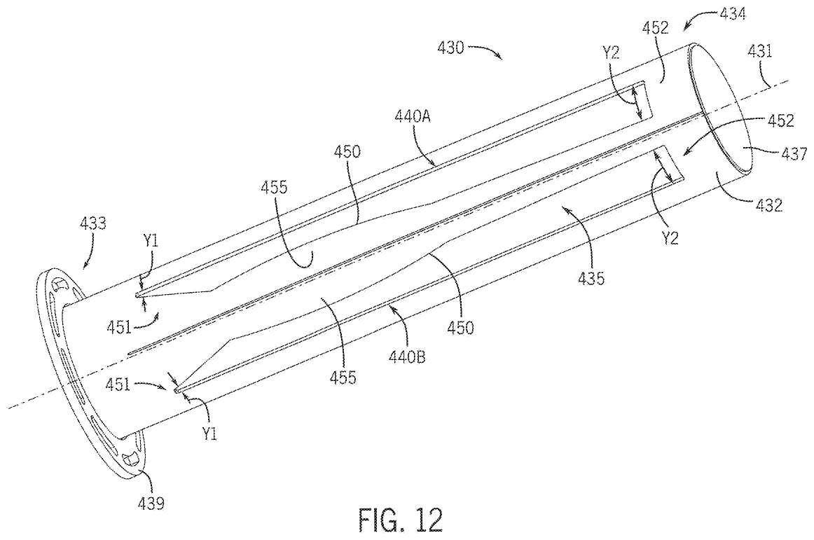

Referring now to FIGS. 11-13, another example antenna 430 according to the present disclosure is depicted. The antenna 430 depicted in FIGS. 11-13 can include one or more features and/or components described with reference to the other example antennas 130, 144 described above and depicted in FIGS. 7-9. Similarly, the example antennas 130, 144 described with reference to FIGS. 7-9 can include any features and/or components of the antenna 430 described herein below with reference to FIGS. 11-13. Note that components and/or features of the antenna 430 described with reference to FIGS. 11-13 that are similar to the components and/or features of the example antennas 130, 144 described with reference to FIGS. 7-9 are denoted with the same names and/or part numbers, however, it should be understood that the use of the same name and/or part numbers for components and/or features in the present disclosure should not be construed to indicate that the similarly marked components and/or features are necessarily identical. Instead, the similarly marked components and/or features may have varying features or characteristics. For example, the antenna holes 140 depicted in FIG. 3 have a different shape than the antenna holes 440A-B depicted in FIG. 12.

The antenna 430 extends along an antenna axis 431 between a first antenna end 433 and an opposite second antenna end 434. The first antenna end 433 is open and has an opening 436. The second antenna end 434 is closed and has a cap 437. The antenna 430 includes an antenna wall 432 that extends between the antenna ends 433, 434, and an interior cavity 435 is defined in the antenna 430. The antenna wall 432 surrounds the interior cavity 435.

The first antenna end 433 can include a flange 439 for coupling to the waveguide assembly 121 (see FIGS. 5-6) with any suitable fasteners such as bolts and/or screws.

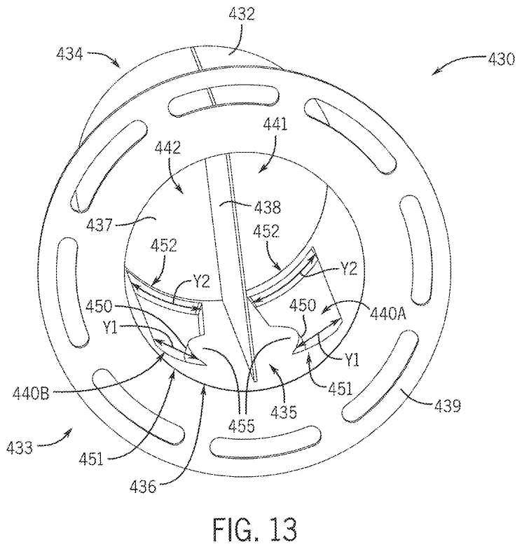

The antenna 430 includes a dividing wall 438 in the interior cavity 435 (see FIG. 13). The dividing wall 438 axially extends between the antenna ends 433, 434 and is coupled to the interior surface of the antenna wall 432. The dividing wall 438 divides the interior cavity 435 into a first chamber 441 and a second chamber 442. The dividing wall 438 also divides the microwaves received into the antenna 430 via the first antenna end 433 such that half of the received microwaves pass into and through the first chamber 441 and while the other half of the received microwaves pass into and through the second chamber 442.

The antenna 440 includes a pair of antenna holes 440A-B in the antenna wall 432 through which microwaves pass out of the antenna 440. Specifically, the microwaves in the first chamber 441 pass through the first antenna hole 440A and the microwaves in the second chamber 442 pass through the second antenna hole 440B. The antenna holes 440A-B are oriented such that microwaves passing through the antenna holes 440A-B are directed onto the belt 84 and the foor products on the belt 84.

The first antenna hole 440A is described in greater detail hereinbelow. Note that the second antenna hole 440B can include any of the features and/or components described for the first antenna hole 440A and some of the features and/or components may be mirrored relative to the first antenna hole 440A.

The first antenna hole 440A has a first antenna hole end 451 and an opposite second antenna hole end 452. The first antenna hole end 451 is located adjacent to the first antenna end 433, and the second antenna hole end 452 is located adjacent to the second antenna end 434. The first antenna hole end 451 has a first width Y1, and the second antenna hole end 452 has a second width Y2. The second width Y2 is greater than the first radial width Y1. The width of the first antenna hole 440A generally tapers from the second antenna hole end 452 to the first antenna hole end 451. In certain examples, each width is curved and/or follows a radius extending from the antenna axis 431. In certain examples, the diameters or widths Y1, Y2 are a value in the range of 2.0-200.0 millimeters and may be at the ends of the noted range. In certain examples, the diameters or widths Y1, Y2 are a value in the range of 10.0-40.0 millimeters and may be at the ends of the noted range.

The width of the first antenna hole 440A increases in a direction away from the first antenna end 433 such that more microwaves pass through the second antenna hole end 452 than the first antenna hole end 451. This advantageously increases the amount of microwaves applied to the food products that pass under the second antenna hole end 452 than the food products that pass under the first antenna hole end 451. The different application of microwaves through the first antenna hole 440A accounts for the differences in product travel speed of the food products on the belt 84. The food products located toward the exterior sidewalls 26, 27 on the outside portion of the belt 84 are conveyed at a greater travel speed than food products located toward the center of the center cavity 60 on the inside portion of the belt 84. The difference in travel speed is due to the spiral or circular path of the belt 84. The antenna 440 advantageously accounts for the differences in travel speed by directing a lesser amount of microwaves through the first antenna hole end 451 to the food products that pass at a slower speed past the first antenna hole end 451 and accordingly, food products near the first antenna end 451 spend more time passing by the first antenna end 451 through which less microwaves are being applied. The antenna 440 also directs a greater amount of microwaves through the first antenna hole 440A nearer the second antenna end 451 to account for food products passing faster by the second antenna end 452. As such, the food products near the second antenna end 451 spend less time passing by the second antenna end 452 but have more microwaves applied thereto. The first antenna hole 440A facilitates even or uniform processing of food products and defines a non-uniform microwave emission profile configured to compensate for differing relative travel speeds of products passing proximate different portions of the first antenna hole 440A. In certain examples, the total amount of microwaves applied (factoring in amount of microwaves passing through the different portions of the first antenna hole 440A and the speed of the products) the food products located toward the exterior sidewalls 26, 27 on the outside portion of the belt 84 is equal to the total amount of microwaves applied to the food products located toward the center of the center cavity 60 on the inside portion of the belt 84. As such, the food products along the inside portion of the belt 84 and the outside portion of the belt 84 are processed the same amount.

In certain examples, the antenna wall 432 includes a projection 455 located between the first antenna hole end 451 and the second antenna hole end 452. The projection 455 narrows the first antenna hole 440A. The projection 455 is configured to focus and distribute microwaves passing through the first antenna hole 440A on the food products. A convex surface 450 extends along the projection 455 and faces the first antenna hole 440a.

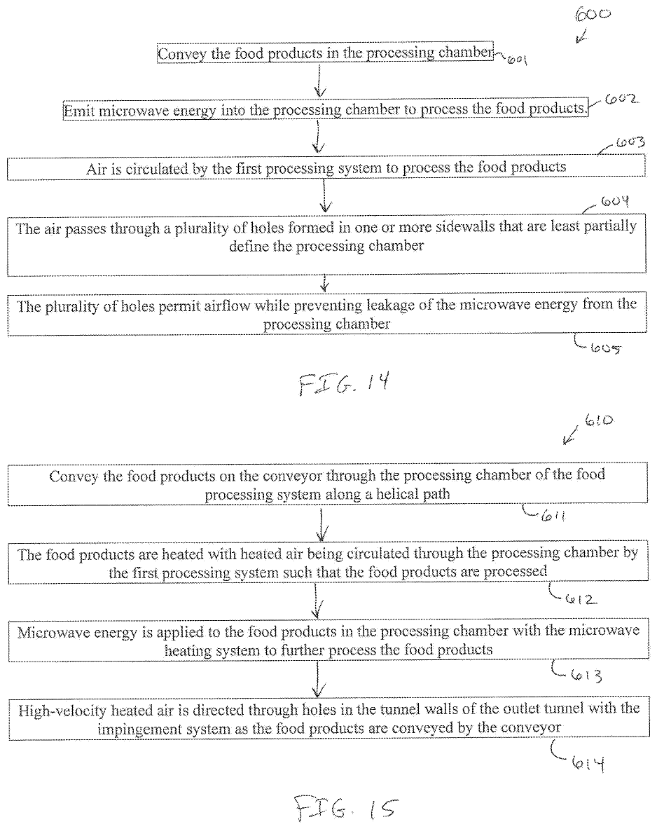

Referring now to FIGS. 14-15 depict example methods according to the present disclosure. The example methods are described below as one or more logic steps, the effects of which may have already been discussed above. It should be understood that one or more steps from any of methods may be incorporated into any other method. Further, the present disclosure contemplates that any combination of individual or multiple steps from any of the methods described herein below may be applicable and/or utilized with the example food processing systems of the present disclosure which are described above and the present disclosure is not limited to the specific combination of steps set forth below in each other example methods and the method may include features, steps, and/or components of the example food processing systems described above.

FIG. 14 depicts an example method 600 for processing food products according the present disclosure. The method 600 includes, at 601, conveying food products in the processing chamber 65 and, at 602, emitting microwave energy into the processing chamber 65 to process the food products. At 603, air is circulated by the first processing system 100 to process the food products. At 604, the air passes through a plurality of holes 32 formed in one or more sidewalls 26, 27, 46, 47 that least partially define the processing chamber 65. At 605, the plurality of holes 32 permit airflow while preventing leakage of the microwave energy from the processing chamber 65.

FIG. 15 depicts another example method 610 for processing rood products according to the present disclosure. The method 610 includes, at 611, conveying the food products on the conveyor 80 through the processing chamber 65 of the food processing system 10 along a helical path. At 612, the food products are heated with heated air being circulated through the processing chamber 65 by the first processing system 100 such that the food products are processed. At 613, microwave energy is applied to the food products in the processing chamber 65 with the microwave heating system 120 to further process the food products. At 614, high-velocity heated air is directed through holes in tunnel walls 7 of the outlet tunnel 75 with the impingement system 112 as the food products are conveyed by the conveyor 80.

In certain examples, any of the methods described herein include conveying food products on the conveyor 80 through the processing chamber 65 along the helical path, heating the food products with heated air circulated through the processing chamber 65 with the first processing system 100 to process the food products, and/or applying microwave energy to the food products in the processing chamber 65 with one or more antennas from the microwave heating system 120 to process the food products, with the one or more antennas extend into the processing chamber 65

The following clauses set out features of the invention which may not be presently claimed but which may form the basis for amendments or future divisional applications.

Clause 1. A food processing system for processing food products, the food processing system comprising:
a housing defining a processing chamber and a center cavity;
a conveyor configured to convey the food products through the processing chamber along a helical path that encircles the center cavity;
a first processing system configured to direct air into the processing chamber to process the food products; and
a microwave heating system configured to generate microwave energy and direct the microwave energy into the processing chamber to process the food products, the microwave heating system includes an antenna extending into the processing chamber through which the microwave energy passes into the processing chamber.

Clause 2. The food processing system according to clause 1, wherein the conveyor includes a belt with a plurality of belt tiers stacked relative to each other within the processing chamber; and
wherein the antenna extends between adjacent belt tiers in the plurality of belt tiers to thereby direct the microwave energy onto the food products.

Clause 3. The food processing system according to clause 1, wherein the center cavity extends along a center axis, and wherein the antenna radially extends into the processing chamber.

Clause 4. The food processing system according to clause 2, wherein the center cavity extends along a center axis, and wherein the antenna radially extends into the processing chamber.

Clause 5. The food processing system according to clause 1, wherein the microwave heating system further includes a magnetron and a waveguide assembly coupled to the magnetron and the antenna.

Clause 6. The food processing system according to clause 5, wherein the magnetron and the waveguide assembly are located in the center cavity.

Clause 7. The food processing system according to clause 1, wherein the housing includes an interior sidewall surrounding the center cavity.

Clause 8. The food processing system according to clause 1, wherein the antenna includes an antenna wall extending between a first antenna end and a second antenna end, the antenna wall defining an interior space and an antenna hole in the antenna wall through which the microwave energy passes.

Clause 9. The food processing system according to clause 8, wherein the antenna is tapered in a direction from the first antenna end to the second antenna end.

Clause 10. The food processing system according to clause 8, wherein the antenna hole is one of a plurality of antenna holes, and wherein the plurality of antenna holes have widths that increase in a direction from the first antenna end to the second antenna end.

Clause 11. The food processing system according to clause 8, wherein the antenna hole has a first antenna hole end near a first antenna end and a second antenna hole end near a second antenna end, and wherein the first antenna hole end has a first width that is less than a second width of the second antenna hole end.

Clause 12. The food processing system according to clause 11, wherein the antenna wall has a projection located between the first antenna hole end and a second antenna hole end, wherein the projection narrows the antenna hole.

Clause 13. The food processing system according to clause 12, wherein the projection has a convex surface that faces the antenna hole.

Clause 14. The food processing system according to clause 8, wherein the antenna includes a dividing wall in an interior cavity of the antenna, the dividing wall dividing the interior cavity into a first chamber and a second chamber.

Clause 15. The food processing system according to clause 14, wherein the antenna hole is a first antenna hole and further comprising a second antenna hole in the antenna wall, and wherein the first antenna hole is configured to permit passage therethrough of the microwave energy in the first chamber and the second antenna hole is configured to permit passage therethrough of the microwave energy in the second chamber.

Clause 16. The food processing system according to clause 14, wherein the antenna includes a first antenna hole through which microwave energy from the first chamber and a second antenna hole through which microwave energy from the second chamber.

Clause 17. The food processing system according to clause 1, wherein the antenna is one antenna in a plurality of antennas that extend into the processing chamber.

Clause 18. The food processing system according to clause 1, wherein the antenna is coupled to the housing.

Clause 19. The food processing system according to clause 1, wherein the housing has a sidewall with a plurality of holes therein, and wherein the plurality of holes permit passage of the air into or out of the processing chamber while preventing leakage of the microwave energy from the processing chamber.

Clause 20. The food processing system according to clause 1, further comprising an impingement system configured to direct high-velocity air through a plurality of holes onto the food products.

Clause 21. A method of processing food products, the method comprising:
conveying food products on a conveyor through a processing chamber of a food processing system along a helical path;
heating the food products with heated air circulated through the processing chamber by a first processing system to process the food products; and
applying microwave energy to the food products in the processing chamber with one or more antennas of a microwave heating system to process the food products, wherein the one or more antennas extend into the processing chamber.

Clause 22. The method according to clause 21, wherein the conveyor includes a belt with a plurality of belt tiers stacked relative to each other within the processing chamber; and
wherein the one or more antennas extend between adjacent belt tiers in the plurality of belt tiers to thereby direct the microwave energy onto the food products.

Clause 23. The method according to clause 21, wherein a center cavity extends along a center axis such that the center cavity is positioned inside the processing chamber, and wherein the antenna radially extends into the processing chamber.

Clause 24. The method according to clause 21, wherein the antenna includes an antenna wall extending between a first antenna end and a second antenna end, the antenna wall defining an interior space and an antenna hole in the antenna wall through which the microwave energy passes.

Clause 25. The method according to clause 24, wherein the antenna is tapered in a direction from the first antenna end to the second antenna end.

Clause 26. The method according to clause 24, wherein the antenna hole is one of a plurality of antenna holes, and wherein the plurality of antenna holes each have a width and the width of each antenna hole increases in a direction from the first antenna end to the second antenna end.

Clause 27. The method according to clause 24, wherein the antenna hole has a first antenna hole end near a first antenna end and a second antenna hole end near a second antenna end, and wherein the first antenna hole end has a first width that is less than a second width of the second antenna hole end.

Clause 28. The method according to clause 27, wherein the antenna wall has a projection located between the first antenna hole end and a second antenna hole end, wherein the projection narrows the antenna hole.

Clause 29. The method according to clause 28, wherein the projection has a convex surface that faces the antenna hole.

Clause 30. A microwave antenna for a food processing system for processing food products, the microwave antenna comprising:
an antenna wall that defines an internal cavity configured to receive microwave energy; and
at least one antenna hole in the antenna wall through which the microwave energy is emitted outwardly from the antenna wall.

Clause 31. The microwave antenna according to clause 30, wherein the antenna extends along an antenna axis that extends between a first antenna end and a second antenna end.

Clause 32. The microwave antenna according to clause 31, wherein the first antenna end is open and defines an opening into an interior space defined by the antenna wall, and wherein the second antenna end is closed.

Clause 33 The microwave antenna according to clause 32, wherein a diameter of the interior space varies along a length of the antenna.

Clause 34. The microwave antenna according to clause 32, wherein the antenna is tapered such that the diameter decreases in a direction away from the first antenna end.

Clause 35. The microwave antenna according to clause 31, wherein the at least one antenna hole is one of a plurality of antenna holes distributed along the antenna axis.

Clause 36. The microwave antenna according to clause 35, wherein widths of the plurality of antenna holes increase in a direction away from the first antenna end.

Clause 37. The microwave antenna according to clause 30, wherein the at least one antenna hole is one of a plurality of antenna holes and the at least one antenna hole is elongated between a first antenna hole end and a second antenna hole end.

Clause 38. The microwave antenna according to clause 37, wherein the at least one antenna hole has a first width at the first antenna hole end and a second width at the second antenna hole end, and wherein the second width is greater than the first width.

Clause 39. The microwave antenna according to clause 37, wherein a width of the antenna hole varies along a length of the antenna hole to establish a non-uniform microwave emission profile along a length of the antenna hole.

Clause 40. The microwave antenna according to clause 39, wherein the non-uniform microwave emission profile is configured to compensate for differing relative travel speeds of food products passing different portions of the antenna hole.

Clause 41. The microwave antenna according to clause 30, wherein the antenna wall includes a projection adjacent to the at least one antenna hole, the projection being configured to shape or focus microwave energy radiated through the at least one antenna hole.

Clause 42. The microwave antenna according to clause 41, wherein the projection has a convex surface that faces the antenna hole.

Clause 43. The microwave antenna according to clause 30, further comprising an internal dividing wall located within an interior space defined by the antenna wall.

Clause 44. The microwave antenna according to clause 43, wherein the internal dividing wall divides the interior space into a first chamber and a second chamber.

Clause 45. The microwave antenna according to clause 44, wherein the antenna wall includes a first antenna hole in communication with the first chamber and a second antenna hole in communication with the second chamber.

Clause 46. The microwave antenna according to clause 30, wherein the antenna wall is configured to be located between belt tiers of a conveyor.

Clause 47. The microwave antenna according to clause 30, wherein the microwave antenna is configured to receive microwave energy from a microwave heating system.

Clause 48. A food processing system for processing food products, the food processing system comprising:
a housing defining a processing chamber and having a sidewall with a plurality of holes therein;
a conveyor extending in the processing chamber and configured to convey the food products through the processing chamber;
a microwave heating system configured to generate microwave energy and direct the microwave energy into the processing chamber to process the food products;
a first processing system configured to circulate air through the processing chamber to process the food products;
wherein the plurality of holes permit passage of the air into or out of the processing chamber while preventing leakage of the microwave energy from the processing chamber.

Clause 49. The food processing system according to clause 48, wherein the conveyor is configured to convey the food products along a helical path.

Clause 50. The food processing system according to clause 48, wherein the first processing system is a forced-air heating system.

Clause 51. The food processing system according to clause 48, wherein each of the plurality of holes has a diameter less than a wavelength of the microwave energy within the processing chamber such that the plurality of holes function as microwave chokes.

Clause 52. The food processing system according to clause 48, wherein the plurality of holes collectively define a microwave choke structure.

Clause 53. The food processing system according to clause 48, wherein the plurality of holes are arranged in a predetermined pattern across the one or more sidewalls to control airflow velocity within the processing chamber.

Clause 54. The food processing system according to clause 48, wherein the plurality of holes are arranged in a first zone and a second zone, and wherein spacing between the holes of the plurality of holes in the first zone is less than spacing between the holes of the plurality of holes in the second zone.

Clause 55. The food processing system according to clause 48, wherein the plurality of holes are arranged in a plurality of axially spaced zones, and wherein spacing between adjacent holes varies between the zones.

Clause 56. The food processing system according to clause 48, wherein the plurality of holes are arranged such that spacing between adjacent holes in the plurality of holes decreases in a downward axial direction to thereby allow for increased airflow velocity at lower axial portions of the processing chamber.

Clause 57. The food processing system according to clause 48, wherein the plurality of holes prevent propagation of microwave energy into a duct enclosure of the first processing system.

Clause 58. The food processing system according to clause 48, wherein the plurality of openings are arranged such that pressure loss across the sidewall is varied along a height of the processing chamber.

Clause 59. The food processing system according to clause 48, further comprising an impingement system configured to direct high-velocity air through a plurality of holes onto the food products.

Clause 60. The food processing system according to clause 48, wherein the microwave heating system includes an antenna extending into the processing chamber through which the microwave energy emit into the processing chamber.

Clause 61. A food processing system for processing food products, the food processing system comprising:
a processing chamber configured to process food products using microwave energy and circulating air;
a microwave heating system configured to generate microwave energy and direct the microwave energy into the processing chamber to process the food products;
a first processing system configured to circulate air through a duct enclosure and the processing chamber to process the food products; and
a sidewall separating the processing chamber from the duct enclosure, the sidewall includes a plurality of holes;
wherein the plurality of holes are configured to prevent transmission of microwave energy through the sidewall and allow for airflow between the duct enclosure and the processing chamber.

Clause 62. The food processing system according to clause 61, further comprising a conveyor is configured to convey the food products along a helical path through the processing chamber.

Clause 63. The food processing system according to clauses 61, wherein the first processing system is a forced-air heating system.

Clause 64. The food processing system according to clause 61, wherein each of the plurality of holes has a diameter less than a wavelength of the microwave energy within the processing chamber such that the plurality of holes function as microwave chokes.

Clause 65. The food processing system according to clause 61, wherein the plurality of holes collectively define a microwave choke structure.

Clause 66. The food processing system according to clause 61, wherein the plurality of holes are arranged in a predetermined pattern across the one or more sidewalls to control airflow velocity within the processing chamber.

Clause 67. The food processing system according to clause 61, wherein the plurality of holes are arranged in a first zone and a second zone, and wherein spacing between the holes of the plurality of holes in the first zone is less than spacing between the holes of the plurality of holes in the second zone.

Clause 68. The food processing system according to clause 61, wherein the plurality of holes are arranged in a plurality of axially spaced zones, and wherein spacing between adjacent holes varies between the zones.

Clause 69. The food processing system according to clause 61, wherein the plurality of holes are arranged such that spacing between adjacent holes in the plurality of holes decreases in a downward axial direction to thereby allow for increased airflow velocity at lower axial portions of the processing chamber.

Clause 70. The food processing system according to clause 61, wherein the plurality of holes prevent propagation of microwave energy into a duct enclosure of the first processing system.

Clause 71. The food processing system according to clause 61, wherein the plurality of openings are arranged such that pressure loss across the sidewall is varied along a height of the processing chamber.

Clause 72. The food processing system according to clause 61, further comprising an impingement system configured to direct high-velocity air through a plurality of holes onto the food products.

Clause 73. The food processing system according to clause 61, wherein the microwave heating system includes an antenna extending into the processing chamber through which the microwave energy emit into the processing chamber.

Clause 74. A method of processing food products, comprising:
conveying food products in a processing chamber;
emitting microwave energy into the processing chamber to process the food products;
circulating air from a first processing system to process the food products; and
passing the air through a plurality of holes formed in a sidewall that at least partially defines the processing chamber,
wherein the plurality of holes permit airflow while preventing leakage of the microwave energy from the processing chamber.

Clause 75. The method according to clause 74, wherein the conveying the food products includes conveying the food products along a helical path.

Clause 76 The method according to clause 74, wherein preventing leakage of the microwave energy includes configuring the plurality of holes to act as microwave chokes.

Clause 77. The method according to clause 74, wherein a diameter of each of the plurality of holes is less than a wavelength of the microwave energy.

Clause 78. The method according to clause 74, wherein spacing between adjacent holes in the plurality of holes at different axial positions varies to control airflow distribution within the processing chamber.

Clause 79. The method according to clause 74, wherein the plurality of holes are configured to prevent the microwave energy from entering a duct enclosure associated with the first processing system

Clause 80. The method according to clause 74, wherein circulating air through the plurality of holes promotes substantially uniform cooking of food products conveyed through different axial positions within the processing chamber.

Clause 81. A food processing system for processing food products, the food processing system comprising:
a housing defining a processing chamber;
a conveyor extending in the processing chamber and configured to convey the food products through the processing chamber along a helical path;
a microwave heating system configured to generate microwave energy and direct the microwave energy into the processing chamber to process the food products;
a first processing system configured to circulate air through the processing chamber to process the food products; and
an impingement system configured to direct air through a plurality of holes onto the food products being conveyed by the conveyor.

Clause 82. The food processing system according to clause 81, wherein the first processing system is a forced-air heating system.

Clause 83. The food processing system according to clause 81, wherein the impingement system includes an impingement chamber and an impingement panel with holes therein, and wherein air is received into the impingement chamber and passes through the holes onto the food products.

Clause 84. The food processing system according to clause 83, wherein the impingement chamber extends along more than half of an uppermost belt tier of the conveyor.

Clause 85. The food processing system according to clause 81, wherein the impingement system is configured to process the food products after processing by the first processing system and the microwave heating system.

Clause 86. The food processing system according to clause 81, wherein the impingement system receives air from the first processing system via a damper.

Clause 87. The food processing system according to clause 81, wherein the impingement system includes a separate processing system that provides airflow which is directed through the plurality of holes.

Clause 88. The food processing system according to clause 81, wherein a layout of the holes in an impingement panel of the impingement system varies based on differences in product travel speed between an inner radius and an outer radius of the conveyor.

Clause 89. The food processing system according to clause 81, wherein the housing has a sidewall with a plurality of holes therein, and wherein the plurality of holes permit passage of the air into or out of the processing chamber while preventing leakage of the microwave energy from the processing chamber.

Clause 90. The food processing system according to clause 81, wherein the microwave heating system includes an antenna extending into the processing chamber through which the microwave energy emits into the processing chamber.

Clause 91. The food processing system according to clause 81, wherein the housing includes an outlet tunnel through which the conveyor extends;
wherein the outlet tunnel includes tunnel walls; and
wherein the impingement system is configured to direct the air through holes in tunnel walls of the outlet tunnel.

Clause 92. The food processing system according to clause 91, wherein the outlet tunnel extends along more than half of an uppermost belt tier of the conveyor.

Clause 93. A food processing system for processing food products, the food processing system comprising:
a housing defining a processing chamber;
a conveyor with a belt configured to convey food products through the processing chamber along a helical path, wherein the belt includes a plurality of belt tiers in a stacked configuration;
a microwave heating system configured to generate microwave energy and direct the microwave energy into the processing chamber to process the food products;
a first processing system configured to circulate heated air through the processing chamber to process the food products; and
an impingement system with an impingement panel and an impingement chamber in the processing chamber configured to direct air flow through holes in the impingement panel onto the food products being conveyed by the conveyor along the helical path.

Clause 94. The food processing system according to clause 93, wherein the first processing system is a forced-air heating system.

Clause 95. The food processing system according to clause 93, wherein the impingement chamber is in the processing chamber.

Clause 96. The food processing system according to clause 93, wherein the impingement chamber extends along more than half of an uppermost belt tier of the conveyor.

Clause 97. The food processing system according to clause 93, wherein the impingement system is configured to process the food products after processing by the first processing system and the microwave heating system.

Clause 98. The food processing system according to clause 93, wherein the impingement system receives air from the first heating system via a damper.

Clause 99. The food processing system according to clause 93, wherein the impingement system includes a separate processing system that provides airflow which is directed through the plurality of holes.

Clause 100. The food processing system according to clause 93, wherein a layout of the holes in an impingement panel of the impingement system varies based on differences in product travel speed between an inner radius and an outer radius of the conveyor.

Clause 101. The food processing system according to clause 93, wherein the housing has a sidewall with a plurality of holes therein, and wherein the plurality of holes permit passage of the air into or out of the processing chamber while preventing leakage of the microwave energy from the processing chamber.

Clause 102. The food processing system according to clause 93, wherein the microwave heating system includes an antenna extending into the processing chamber through which the microwave energy emits into the processing chamber.

Clause 103. A method of processing food products, the method comprising:
conveying food products on a conveyor through a processing chamber of a food processing system along a helical path;
heating the food products with heated air circulated through the processing chamber by a first processing system to process the food products;
applying microwave energy to the food products in the processing chamber with a microwave heating system to process the food products; and
directing air through holes in an impingement panel of an impingement system onto the food products being conveyed by the conveyor.

Clause 104. The method according to clause 103, wherein directing the air occurs after heating the food products with the first processing system and after applying microwaves to the food products with the microwave heating system.

Clause 105. The method according to clause 103, wherein the impingement system receives the heated air from the first processing system via a damper.

Clause 106. The method according to clause 103, wherein the impingement panel extends along more than half of an uppermost belt tier of the conveyor.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and methods described herein may be used alone or in combination with other apparatuses, systems, and methods. It is to be expected that various equivalents, alternatives, and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A food processing system for processing food products, the food processing system comprising:
a housing defining a processing chamber and a center cavity;
a conveyor configured to convey the food products through the processing chamber along a helical path that encircles the center cavity;
a first processing system configured to direct air into the processing chamber to process the food products; and
a microwave heating system configured to generate microwave energy and direct the microwave energy into the processing chamber to process the food products, the microwave heating system includes an antenna extending into the processing chamber through which the microwave energy passes into the processing chamber.

2. The food processing system according to claim 1, wherein the conveyor includes a belt with a plurality of belt tiers stacked relative to each other within the processing chamber; and
wherein the antenna extends between adjacent belt tiers in the plurality of belt tiers to thereby direct the microwave energy onto the food products.

3. The food processing system according to claim 1, wherein the center cavity extends along a center axis, and wherein the antenna radially extends into the processing chamber.

4. The food processing system according to claim 2, wherein the center cavity extends along a center axis, and wherein the antenna radially extends into the processing chamber.

5. The food processing system according to claim 1, wherein the microwave heating system further includes a magnetron and a waveguide assembly coupled to the magnetron and the antenna.

6. The food processing system according to claim 5, wherein the magnetron and the waveguide assembly are located in the center cavity.

7. The food processing system according to claim 1, wherein the housing includes an interior sidewall surrounding the center cavity.

8. The food processing system according to claim 1, wherein the antenna includes an antenna wall extending between a first antenna end and a second antenna end, the antenna wall defining an interior space and an antenna hole in the antenna wall through which the microwave energy passes.

9. The food processing system according to claim 8, wherein the antenna is tapered in a direction from the first antenna end to the second antenna end.

10. The food processing system according to claim 8, wherein the antenna hole is one of a plurality of antenna holes, and wherein the plurality of antenna holes have widths that increase in a direction from the first antenna end to the second antenna end.

11. The food processing system according to claim 8, wherein the antenna hole has a first antenna hole end near a first antenna end and a second antenna hole end near a second antenna end, and wherein the first antenna hole end has a first width that is less than a second width of the second antenna hole end.

12. The food processing system according to claim 11, wherein the antenna wall has a projection located between the first antenna hole end and a second antenna hole end, wherein the projection narrows the antenna hole.

13. The food processing system according to claim 12, wherein the projection has a convex surface that faces the antenna hole.

14. The food processing system according to claim 8, wherein the antenna includes a dividing wall in an interior cavity of the antenna, the dividing wall dividing the interior cavity into a first chamber and a second chamber.

15. The food processing system according to claim 14, wherein the antenna hole is a first antenna hole and further comprising a second antenna hole in the antenna wall, and wherein the first antenna hole is configured to permit passage therethrough of the microwave energy in the first chamber and the second antenna hole is configured to permit passage therethrough of the microwave energy in the second chamber.

16. The food processing system according to claim 14, wherein the antenna includes a first antenna hole through which microwave energy from the first chamber and a second antenna hole through which microwave energy from the second chamber.

17. The food processing system according to claim 1, wherein the antenna is one antenna in a plurality of antennas that extend into the processing chamber.

18. The food processing system according to claim 1, wherein the antenna is coupled to the housing.

19. The food processing system according to claim 1, wherein the housing has a sidewall with a plurality of holes therein, and wherein the plurality of holes permit passage of the air into or out of the processing chamber while preventing leakage of the microwave energy from the processing chamber.

20. The food processing system according to claim 1, further comprising an impingement system configured to direct high-velocity air through a plurality of holes onto the food products.
